(19) United States
(12) Patent Application Publication
(10) Pub. No.: US 2026/0303226 A1
(43) Pub. Date: Oct. 1, 2026

(54) DYNAMIC RETUNING OF ELECTRONIC DEVICE ANTENNAS BASED ON DEVICE POSITION IN FREE SPACE

(71) Applicant: Viavi Solutions Inc., Chandler, AZ (US)

(72) Inventor: Thomas Sevilla, Miami, FL (US)

(73) Assignee: Viavi Solutions Inc., Chandler, AZ (US)

(21) Appl. No.: 19/091,398

(22) Filed: Mar. 26, 2025

(51) Int. Cl. H04B 17/10; H04B 17/11; H04B 17/27; H04B 17/391

(52) U.S. Cl. CPC H04B 17/101; H04B 17/11; H04B 17/27; H04B 17/3913

(57) ABSTRACT

Embodiments disclosed herein may allow for retuning of an antenna (or a set of antennas) in a electronic device. The retuning may mitigate the technical problem of the antenna being detuned based on location and/or orientation of the electronic device, and the proximity of objects and human body parts to the electronic device. For the retuning, different mechanical/electromechanical/thermal sensors within the electronic device may measure the location and/or the orientation of the electronic device, and one or more proximity sensors may determine whether an object and/or a human body part is close to the device. Based on the measurements, a processor may implement one or more rules based models and/or one or more machine learning based models to calculate retuning parameters. The processor may use the retuning parameters to retune the antennas through one or more radio frequency (RF) front end circuits.

### BACKGROUND

Electronic devices—including both mobile devices such as cellular phones and stationary devices such as Wi-Fi routers—and Internet of Things (IoT) devices form a major part of modern communication systems. The use of cellular phones, particularly smartphones, has exploded in the past few decades. There also has been a concomitant increase in use of IoT devices, such as smart home devices (e.g., voice assistants, doorbells, etc.), smart watches, pet trackers, etc. All of these devices are generally carried by humans or attached to animals (e.g., pets), such that these devices are generally in motion and experience changes to their orientation. Additionally, portions of these devices may be attached with different human body parts (e.g., hand for a cellphone) and/or pet body parts. These devices may also be in proximity to other objects that may block transmission/reception of radio waves.

A major technical challenge due to this constant mobility, changes to the orientation, and different portions of touching human/animal body parts is the detuning of the antennas in these devices. Such detuning decreases the antenna efficiency, lowering the radiation power received/generated by the device antenna, which is undesirable. Therefore, significant improvement in dynamically mitigating antenna detuning in electronic devices is desired.

### SUMMARY

Embodiments disclosed herein solve the aforementioned technical problems and may provide other solutions as well. Multiple sensors in the electronic device may measure location, orientation, and environmental attributes of the electronic device. A processor in the electronic device may intake the sensor measurements, determine retuning parameters based on the sensor measurements, and retune the antenna using the retuning parameters. The processor may use one or more rules based models and/or machine learning models to determine the retuning parameters. The processor may use the retuning parameters to retune the antenna. The retuning may include, for example, adjusting antenna polarization, antenna aperture, and/or antenna impedance.

In one or more embodiments, a system for retuning an antenna in a electronic device is provided. The system may include one or more sensors configured to measure location and orientation of the electronic device, and environmental attributes around the electronic device. The system may further include a processor configured to determine retuning parameters for the antenna based on at least one of the measured location, orientation, and environmental attributes. The processor is further configured to retune the antenna using the retuning parameters.

In one or more embodiments, a method of retuning an antenna in a electronic device is provided. The method may include measuring, by one or more sensors of the electronic device, location and orientation of the electronic device, and environmental attributes around the electronic device. The method may further include determining, by a processor of the electronic device, retuning parameters for the antenna based on at least one of the measured location, orientation, and environmental attributes. The method may additionally include retuning, by the processor, the antenna using the retuning parameters.

It should be understood that this summary just provides example embodiments for a quick introduction of the disclosure and should not be considered limiting.

### BRIEF DESCRIPTION OF THE DRAWINGS

FIG. 1 shows an example electronic device based on the principles disclosed herein.

FIG. 2 shows a software architecture for dynamic retuning of antennas of electronic devices based on the principles disclosed herein.

FIG. 3 is a flowchart of an example method for retuning an antenna in a electronic device based on the principles disclosed herein.

It should be understood that the drawings are just for illustrating the principles disclosed herein and should not be considered limiting.

### DETAILED DESCRIPTION OF SEVERAL EMBODIMENTS

Embodiments disclosed herein may allow for retuning of an antenna (or a set of antennas) in an electronic device. The retuning may mitigate the technical problem of the antenna being detuned based on location and/or orientation of the electronic device, and proximity of objects and human body parts to the electronic device. For the retuning, different mechanical/electromechanical/thermal sensors within the electronic device may measure the location and/or the orientation of the electronic device, and one or more proximity sensors may determine whether an object and/or a human body part is close to the device. Alternatively or additionally, optical sensors such as cameras may also be used to determine proximity to an object. Based on the measurements, a processor in the electronic device may implement one or more rules based models and/or one or more machine learning based models to calculate retuning parameters. The processor may use the retuning parameters to retune the antennas through one or more radio frequency (RF) front end circuits.

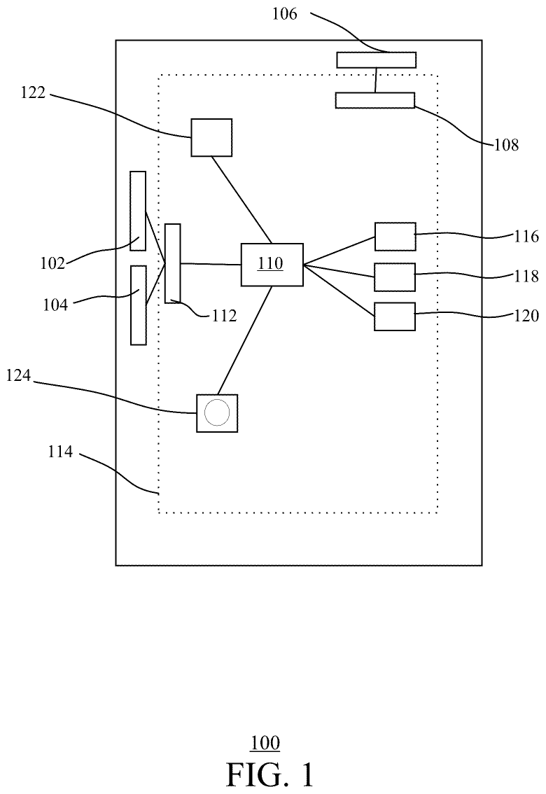

FIG. 1 shows an example electronic device 100 (e.g., a mobile device) based on the principles disclosed herein. The electronic device 100 should be understood to include any kind of smartphone, smart device, IoT device, and/or any kind of wireless communication device that communicate with other wireless devices and/or access points (e.g., Wi-Fi routers). The electronic device 100 may be carried by a person, e.g., a handheld smartphone and/or adhered to a pet, e.g., a pet tracker. Generally, the electronic device 100 may be in motion, its orientation may be changing, and portions of the electronic device 100 may be obstructed by a human body part and/or animal body part.

For the wireless communications, the electronic device may include a plurality of antennas 102, 104, 106, which may support various wireless communication protocols. For example, antenna 102 may be a Bluetooth antenna, antenna 104 may a Wi-Fi antenna, and antenna 106 may be a cellular antenna. It should however be understood that the Bluetooth antenna 102, Wi-Fi antenna 104, and cellular antenna 106 are merely examples and should not be considered limiting. That is, the electronic device 100 may have antennas supporting other communication protocols such as near field communication (NFC), mmWave (it should be noted that mmWave may be supported by the cellular antenna 106), etc. The antennas 102, 104, 106 may be connected to corresponding radio frequency (RF) front ends. For example, the Bluetooth antenna 102 and the Wi-Fi antenna may be connected a RF front end 112 and the cellular antenna 106 may be connect to RF front end 108. The RF front ends 112, 108 may include corresponding circuits to generate the transmission data and process the received data for the corresponding antennas 102, 104, 106. A processor 110 may control the antennas 102, 104, 106 through the corresponding RF front ends 112, 108. Additionally, the processor 110 may further instruct the RF front ends 112, 108 to retune the antennas 102, 104, 106 based on the principles disclosed herein. In one or more embodiments, the electronic device 100 may include a display 114 that allows a user to interact with the electronic device 100.

As the electronic device 100 moves and changes orientation, the antennas 102, 104, 106 may be detuned. For example, the motion and/or the orientation change may cause the antennas 102, 104, 106 to change the polarities of communication with antennas of other devices and/or access points. Additionally, when the antennas 102, 104, 106 are covered by a human body part, there may be a change in frequency band. There may also be a change in the transmitted and receiving energy of the radio frequency (RF) signals from one or more of the antennas 102, 104, 106. Furthermore, the antennas 102, 104, 106 may be come in proximity to transmission/reception signal blocking objects, which could also cause undesirable issues.

The electronic device 100 may include multiple types of sensors. For example, the electronic device 100 may include motion/mechanical sensors such as a micro-electromechanical system (MEMS) accelerometer 116, gyroscope 118, thermal accelerometer 120, and/or the like. The electronic device 100 may also include a proximity sensor 122. The electronic device 100 may further include optical sensor 124 such as a camera. Using the measurements of these sensors 116, 118, 120, 122, 124 the processor 110 may determine, among other things, the orientation of the electronic device 100.

The operation of the MEMS accelerometer 116 is known in the art, and therefore will not be described in detailed herein. At a high level, a MEMS accelerometer 116 translates a mechanical effect to an electronic signal, which will be used by the processor 110 to determine the location and/or orientation of the electronic device 100. For example, a movable spring can be disposed in between other components, and when the spring moves in relation to the other components, e.g., due to the gravity vector, a capacitance between the spring and the other components changes. The changed capacitance can be processed electronically (e.g., within the MEMS accelerometer 116 itself and/or by the processor 110) to determine the location and/or orientation of the electronic device 100.

Gyroscope 118 is also known in the art, may include mechanical and/or electronic components that use the principle of angular momentum to measure the orientation of the electronic device 100 with respect to the ground. Thermal accelerometer 120, also known in the art, is based on temperature asymmetry due to roll or tilt. A central heating beam and a symmetric thermometer array is disposed within a cavity. For a planar orientation, the temperature distribution is symmetric. When there is a change in the orientation (e.g., parallel to the ground), the temperature distribution becomes asymmetric and can be used to measure the orientation of the electronic device. Proximity sensor 122 is also known in the art and may use any kind of technology (e.g., reflection of radiation) to detect whether an object (e.g., human body part) is located in proximity to the electronic device 100. Optical sensor 124 is also known in the art and may use any kind of optical determine whether an object is located in proximity to the electronic device 100.

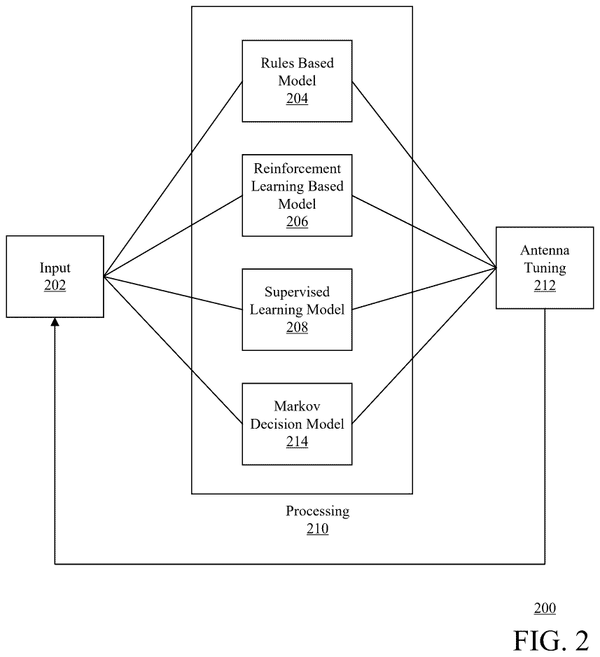

FIG. 2 shows a software architecture 200 for dynamic retuning of antennas of electronic devices, based on the principles disclosed herein. It should be understood that the software architecture 200 is merely exemplary and should not be considered limiting. That is, software architectures with additional, alternative, or fewer number of components should be considered within the scope of this disclosure. As shown, the software architecture 200 may include an input module 202, a processing module 210, and antenna tuning module 212. The software architecture may be implemented by any permutation of components within the electronic device 100 described above. For example, the processor 110 may implement the processing module 210.

The input module 202 may receive the sensor measurements from one or more of the sensors 116, 118, 120, 122. In one or more embodiments, the input module 202 may receive the antenna tuning parameters as a feedback from the antenna tuning module 212. The input module 202 may provide the received sensor measurements to the processing module 210 and/or feedback from the antenna tuning module 212 to calculate antenna tuning parameters.

In one or more embodiments, the processing module 210 may include a rules based model 204, a reinforcement learning based model 206, a supervised learning model 208, and Markov decision model 214. It should be understood that these components of the processing module 210 are intended as examples and should not be considered limiting. The described models may operate in parallel and/or sequentially to determine the antenna tuning parameters.

The rules based model 204 may use pre-determined rules to calculate the antenna tuning parameters. The pre-determined rules may be based on experimentation and/or numerical simulation. For example, the pre-determined rules may encode mathematical relationships between the measurements from one or more sensors 116, 118, 120, 122 and the optimal antenna tuning parameters. These mathematical expressions may be hardcoded within the software code implemented by the rules based model 204.

In one or more embodiments, the processing module 210 may include a reinforcement learning-based model 206 such as Q-learning, Deep Q-Network, Proximal Policy optimization, soft actor-critic type model, and/or the like. The reinforcement learning-based model 206 may learn the value of each action, e.g., antenna tuning by an antenna tuning module 212 and received as a feedback, transmission and/or reception improvements based on the antenna tuning, and/or the like, to maximize the reward from the action. The reward may include, for example, improvements in transmission/reception efficiency of the electronic device 100, maximization of the power consumed by the electronic device 100. The reinforcement learning-based model may therefore learn the desired consequences and antenna tuning parameters corresponding to those desired actions.

In one or more embodiments, the processing module 210 may include a supervised learning model 208. The supervised learning model 208 may include neural networks that may learn to optimize antenna radiation/tuning based on the experienced environment (e.g., proximity to a human body part and/or another object). That is, neural networks may capture complex relationships between input features (e.g., position, object proximity, overall environment) and tuning parameters (antenna gain, radiation pattern, tuning, etc.). The supervised learning model 208 may also include autoencoders that may establish a form of unsupervised learning. Using the autoencoders, the neural networks learn the efficient representations of the data from the input module 202 and can use this to detect anomalies in antenna performance and improve upon those anomalies.

In one or more embodiments, the processing module 210 may include a Markov decision module 214. The Markov decision module 214 may utilize the optimal antenna tuning parameters determined by the reinforcement learning based model 206 and/or the supervised learning model to dynamically tune an antenna or sets of antennas. Some examples of dynamic tuning may include adaptive beam forming, frequency selection, power control, antenna configuration, and/or combination of two or more of the above. In these cases, the Markov decision module 214 may determine the optimal beam direction, frequency channel, transmission power, or antenna configuration in a dynamic environment to maximize signal quality and adapt to changing user locations and environmental factors.

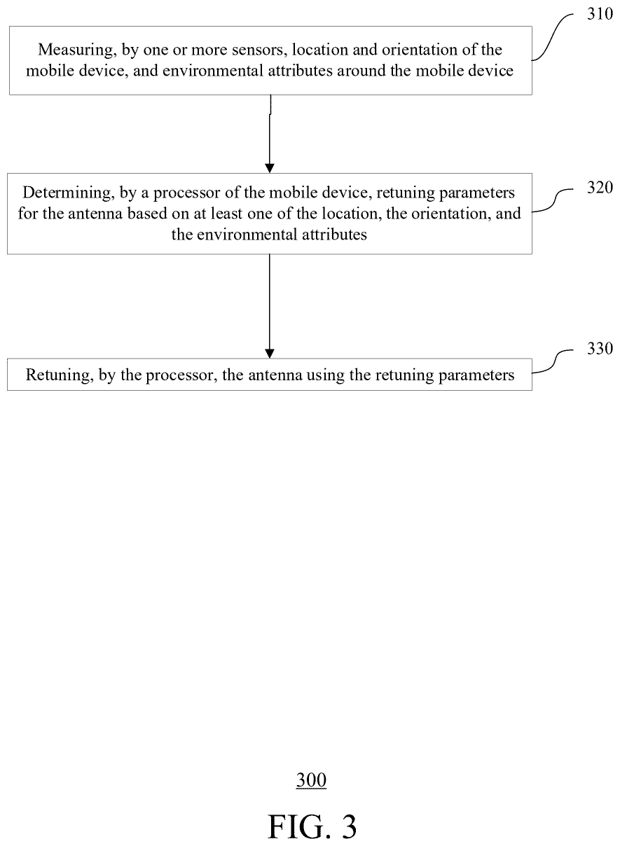

FIG. 3 is a flowchart of an example method 300 for retuning an antenna in a electronic device, based on the principles disclosed herein. The method 300 may be implemented by any permutation of components of a electronic device (e.g., electronic device 100 shown in FIG. 1). The steps of the method 300 described below are merely examples and should not be considered limiting. That is, methods with additional, alternative, or fewer number of steps should be considered within the scope of this disclosure.

At step 310, one or more sensors of the electronic device may measure location and orientation of the electronic device, and environmental attributes around the electronic device. The sensors may include, for example, a MEMS accelerometer, a thermal accelerometer, a gyroscope, and a proximity sensor, and/or the like. The location may include the location of the electronic device in free space, and such location may periodically change thereby causing a need for the retuning. The orientation of the electronic device may be based on how the electronic device is being carried by a person, e.g., how the electronic device is being held in a hand. The environmental attribute may be the proximity of the electronic device to a human body part and/or an object.

At step 320, a processor of the electronic device may determine retuning parameters for the antenna based on at least one of the location, the orientation, and the environmental attributes. The retuning parameters may include aperture, polarization, impedance, and/or the like for the antenna in the electronic device.

At step 330, the processor of the electronic device may retune the antenna using the retuning parameters. For example, the processor may cause a retuning circuit at the RF front end to change the aperture, impedance, and/or the like. The retuning may cause the maximum transmission power from the electronic device and/or maximum reception power to the electronic device.

While various embodiments have been described above, it should be understood that they have been presented by way of example and not limitation. It will be apparent to persons skilled in the relevant art(s) that various changes in form and detail can be made therein without departing from the spirit and scope. In fact, after reading the above description, it will be apparent to one skilled in the relevant art(s) how to implement alternative embodiments. For example, other steps may be provided, or steps may be eliminated, from the described flows, and other components may be added to, or removed from, the described systems. Accordingly, other implementations are within the scope of the following claims.

In addition, it should be understood that any figures which highlight the functionality and advantages are presented for example purposes only. The disclosed methodology and system are each sufficiently flexible and configurable such that they may be utilized in ways other than that shown.

Although the term “at least one” may often be used in the specification, claims and drawings, the terms “a”, “an”, “the”, “said”, etc. also signify “at least one” or “the at least one” in the specification, claims and drawings.

Finally, it is the applicant's intent that only claims that include the express language “means for” or “step for” be interpreted under 35 U.S.C. 112(f). Claims that do not expressly include the phrase “means for” or “step for” are not to be interpreted under 35 U.S.C. 112(f).

What is claimed is:

1. A system for retuning an antenna in an electronic device, the system comprising:
one or more sensors configured to measure location and orientation of the electronic device, and environmental attributes around the electronic device; and
a processor configured to:
determine retuning parameters for the antenna based on at least one of the measured location, orientation, and environmental attributes; and
retune the antenna using the retuning parameters.

2. The system of claim 1, the processor being configured to determine the retuning parameters using a rules based model.

3. The system of claim 1, the processor being configured to determine the retuning parameters using a reinforcement learning based model.

4. The system of claim 1, the processor being configured to determine the retuning parameters using a supervised learning model.

5. The system of claim 1, the processor being configured to determine the retuning parameters using a Markov decision model.

6. The system of claim 1, the one or more sensors comprising at least one of a micro-electromechanical accelerometers, thermal accelerometers, gyroscopes, and proximity sensors.

7. The system of claim 1, the environmental attributes comprising a proximity of an object to the electronic device.

8. The system of claim 1, the environmental attributes comprising a proximity of a human body part to the electronic device.

9. The system of claim 1, the processor configured to retune the antenna by adjusting an aperture and/or impedance of the antenna.

10. The system of claim 1, the processor configured to retune the antenna by adjusting a polarization of the antenna.

11. A method of retuning an antenna in a electronic device, the method comprising:
measuring, by one or more sensors of the electronic device, location and orientation of the electronic device, and environmental attributes around the electronic device;
determining, by a processor of the electronic device, retuning parameters for the antenna based on at least one of the measured location, orientation, and environmental attributes; and
retuning, by the processor, the antenna using the retuning parameters.

12. The method of claim 11, further comprising:
determining, by the processor, the retuning parameters using a rules based model.

13. The method of claim 11, further comprising:
determining, by the processor, the retuning parameters using a reinforcement learning based model.

14. The method of claim 11, further comprising:
determining, by the processor, the retuning parameters using a supervised learning model.

15. The method of claim 11, further comprising:
determining, by the processor, the retuning parameters using a Markov decision model.

16. The method of claim 11, the one or more sensors comprising at least one of a micro-electromechanical accelerometers, thermal accelerometers, gyroscopes, and proximity sensors.

17. The method of claim 11, the environmental attributes comprising a proximity of an object to the electronic device.

18. The method of claim 11, the environmental attributes comprising a proximity of a human body part to the electronic device.

19. The method of claim 11, further comprising:
retuning, by the processor, the antenna by adjusting an aperture and/or impedance of the antenna.

20. The method of claim 11, further comprising:
retuning, by the processor, the antenna by adjusting a polarization of the antenna.
